(19) United States
(12) Patent Application Publication
(10) Pub. No.: US 2015/0055806 A1
(43) Pub. Date: Feb. 26, 2015

(54) AUDIO ADJUSTMENT CIRCUIT AND ELECTRONIC DEVICE USING SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: LU-QING MENG, Shenzhen (CN); CHUN-LUNG HUNG, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/230,236

(22) Filed: Mar. 31, 2014

(30) Foreign Application Priority Data
Aug. 22, 2013 (CN) 2013103672557

(51) Int. Cl. H04R 3/00

(52) U.S. Cl. CPC H04R 3/00
USPC 381/123

(57) ABSTRACT

An electronic device includes a power supply, an adjustment circuit, and an audio outputting module. The power supply provides a working voltage. The adjustment circuit includes a control unit, a switch unit, and an adjustment unit. The control unit comprises a first pin and a second pin for outputting a first control signal or a second control signal respectively. When received first control signal from the control unit, the switch unit establishes a connection between the power supply and the adjustment unit, and the adjustment unit generates different driving voltages based on different combination of the first control signal and the second control signal outputted by the first pin and the second pin. The audio outputting module generates different tone frequencies based on different driving voltage.

### FIELD

The present disclosure relates to an audio adjustment circuit and an electronic device using the audio adjustment circuit.

### BACKGROUND

Electronic devices, such as televisions and air conditioners, include a buzzer for indicating abnormal states of the electronic devices. However, there is only one tone frequency outputted to indicate different abnormal states, so it is inconvenient to determine the cause of the abnormal state.

### BRIEF DESCRIPTION OF THE FIGURES

The components of the drawings are not necessarily drawn to scale, the emphasis instead being placed upon clearly illustrating the principles of the embodiment of an electronic device. Moreover, in the drawings, like reference numerals designate corresponding parts throughout several views.

FIG. 1 is a block view of an embodiment of an electronic device.

FIG. 2 is a circuit diagram of an embodiment of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.” Embodiments of the present disclosure will be described in detail with reference to the drawings.

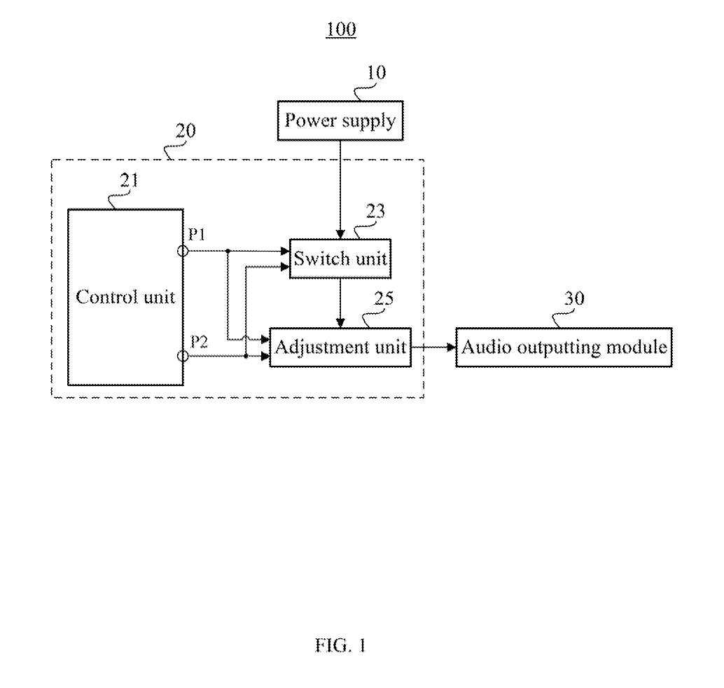

FIG. 1 shows an embodiment of an electronic device 100. The electronic device 100 is capable of outputting different tone frequencies.

The electronic device 100 includes a power supply 10, an adjustment circuit 20, and an audio outputting module 30.

The power supply 10 provides a working voltage. In one embodiment, the working voltage is 5 volts.

The adjustment circuit 20 can be electrically coupled between the power supply 10 and the audio outputting module 30. The adjustment circuit 20 can receive the working voltage from the power supply 10 and outputs different driving voltages to the audio outputting module 30. The adjustment circuit 20 can include a control unit 21, a switch unit 23, and an adjustment unit 25.

The control unit 21 can be electrically connected to the switch unit 23 and the adjustment unit 25. The control unit 21 can include a first pin P1 and a second pin P2. The first pin P1 and the second pin P2 can each output a first control signal and a second control signal to the switch unit 23 and the adjustment unit 25. In one embodiment, based on different states of the electronic device 100, the control unit 21 can control the first pin P1 and the second pin P2 to output the first control signal and/or the second control signal in different combination. In one embodiment, the first control signal can be logic-high signal, and the second control signal can be a logic-low signal.

The switch unit 23 is electrically connected to the power supply 10, the control unit 21, and the adjustment unit 25. The switch unit 23 can electrically couple the power supply 10 to the adjustment unit 25 when at least one of the first pin P1 or the second pin P2 outputs the first control signal. The switch unit 23 can disconnect the power supply 10 from the adjustment unit 25 when both the first pin P1 and the second pin P2 output the second control signal.

The adjustment unit 25 can be electrically connected to the control unit 21, the switch unit 23, and the audio outputting module 30. The adjustment unit 25 outputs different driving voltages to the audio outputting module 30 based on different combinations of the first and second control signals outputted by the control unit 21 when the power supply 10 is electrically coupled to the adjustment unit 25. When both of the first pin P1 and the second pin P2 output the first control signal, the adjustment unit 25 can output a first driving voltage. When the first pin P1 outputs the first control signal and the second pin P2 outputs the second control signal, the adjustment unit 25 can output a second driving voltage. When the first pin P1 outputs the second control signal and the second pin P2 outputs the first control signal, the adjustment unit 25 can output a third driving voltage. The adjustment unit 25 can stop outputting driving voltages when the switch unit 23 decouples the power supply 10 from the adjustment unit 25. In one embodiment, the values of the first driving voltage, the second driving voltage, and the third driving voltage can decrease in that order. The first driving voltage is substantially equal to the working voltage.

The audio outputting module 30 can be electrically connected to the adjustment unit 25. The audio outputting module 30 can output different tone frequencies based on the different driving voltages. In one embodiment, the audio outputting module 30 is a buzzer. The tone frequencies are directly proportional to the values of the driving voltage. In another embodiment, the audio outputting module 30 can output a same tone frequency with different volumes based on the different driving voltages.

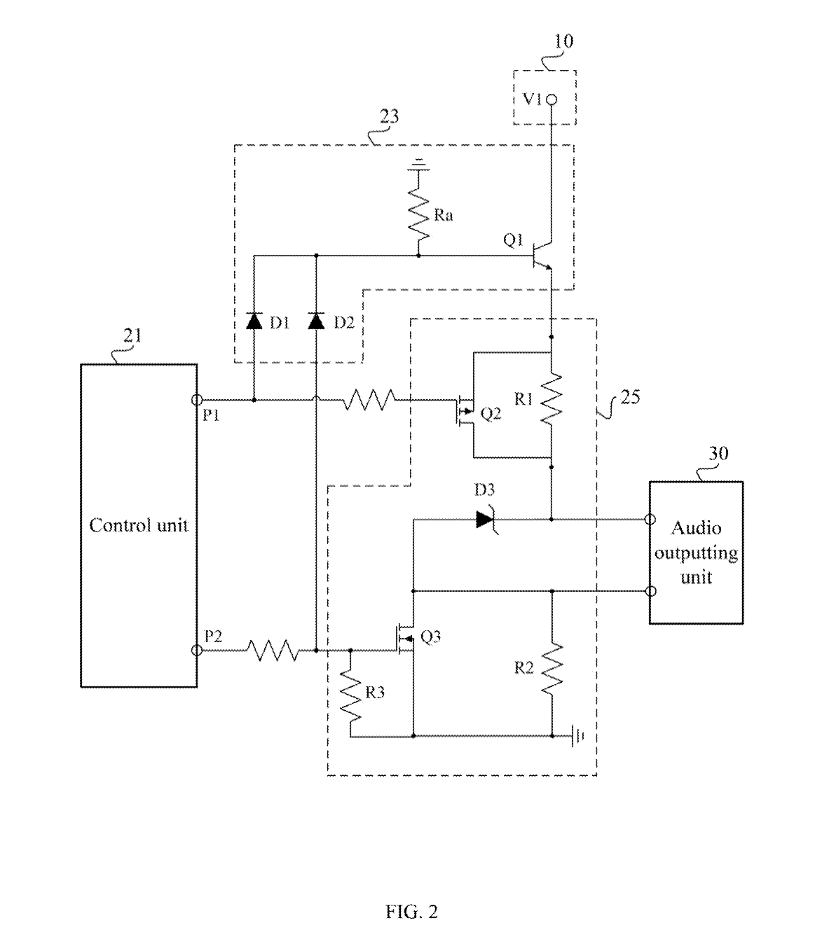

FIG. 2 shows that the power supply 10 can include a power source V1.

The switch unit 23 can include a first transistor Q1, a first diode D1, a second diode D2, and a first resistor Ra. A base of the first transistor Q1 can be electrically connected to the first pin P1 through the first diode D1. An emitter of the first transistor Q1 can be electrically connected to the adjustment unit 25. A collector of the first transistor Q1 can be electrically connected to the power source V1. An anode of the first diode D1 can be connected to the first pin P1. A cathode of the first diode D1 can be electrically connected to the base of the first transistor Q1. An anode of the second diode D2 can be electrically connected to the second pin P2. A cathode of the second diode D2 can be electrically connected to the base of the first transistor Q1. A first terminal of the first resistor Ra can be electrically connected to the base of the first transistor Q1. A second terminal of the first resistor Ra can be grounded. In one embodiment, the first transistor Q1 can be an npn-type bipolar junction transistor.

The adjustment unit 25 can include a second transistor Q2, a third transistor Q3, a third diode D3, a first limiting resistor R1, a second limiting resistor R2, and a third limiting resistor R3. A gate of the second transistor Q2 can be connected to the first pin P1. A source of the second transistor Q2 can be connected to the emitter of the first transistor Q1. A drain of the second transistor Q2 can be electrically connected to the audio outputting module 30. A gate of the third transistor Q3 can be electrically connected to the second pin P2. A source of the third transistor Q3 can be grounded. A drain of the third transistor Q3 can be electrically connected to the audio outputting module 30 through the third diode D3. An anode of the third diode D3 can be electrically connected to the drain of the third transistor Q3. A cathode of the third diode D3 can be electrically connected to the drain of the second transistor Q2. The first limiting resistor R1 can be electrically connected between the source and the drain of the second transistor Q2. The second limiting resistor R2 can be electrically connected between the source and the drain of the third transistor Q3. The third limiting resistor R3 can be electrically connected between the gate and the source of the third transistor Q3. In one embodiment, the second transistor Q2 can be a p-channel enhancement type-metal oxide semiconductor field-effect transistor (MOSFET), and the third transistor Q3 can be an n-channel enhancement type-metal oxide semiconductor field-effect transistor (MOSFET). A resistance of the second limiting resistor R2 can be four times greater than a resistance of the first limiting resistor R1.

A working method of the electronic device 100 can be described as follow. When both the first pin P1 and the second pin P2 output the first control signal, the first diode D1 and the second diode D2 turn on, and a voltage difference between the base and the emitter of the first transistor Q1 can be greater than 0.7 volt, which can cause the first transistor Q1 to turn on, and the source of the second transistor Q2 to be electrically connected to the power source V1. When the voltage difference between the gate and the source of the second transistor Q2 can be less than 0 volts, the second transistor Q2 can turn on. When the voltage difference between the gate and the source of the third transistor Q3 can be greater than 0 volts, the third transistor Q3 can turn off, which can cause the audio outputting module 30 to output a first tone frequency.

When the first pin P1 outputs the first control signal and the second pin P2 outputs the second control signal, the first diode D1 turns on and the second diode D2 turns off. When the voltage difference between the base and the emitter of the first transistor Q1 can be greater than 0.7 volt, the first transistor Q1 turns on, which can cause the source of the second transistor Q2 to be electrically connected to the power source V1. When the voltage difference between the gate and the source of the second transistor Q2 can be less than 0 volt, the second transistor Q2 can turn on. When the voltage difference between the gate and the source of the third transistor Q3 can be greater than 0 volts, the third transistor Q3 can turn off, which can cause the audio outputting module 30 to output a second tone frequency.

When the first pin P1 outputs the second control signal and the second pin P2 outputs the first control signal, the first diode D1 can turn off and the second diode D2 can turn on. When the voltage difference between the base and the emitter of the first transistor Q1 can be greater than 0.7 volt, the first transistor Q1 turns on, which can cause the source of the second transistor Q2 to be electrically connected to the power source V1. When the voltage difference between the gate and the source of the second transistor Q2 can be greater than 0 volt, the second transistor Q2 can turn off. When the voltage difference between the gate and the source of the third transistor Q3 can be less than 0 volt, the third transistor Q3 can turn on, which can cause the audio outputting module 30 to outputted a third tone frequency.

When both the first pin P1 and the second pin P2 output the second control signal, the first diode D1 can turn off and the second diode D2 can turn on. When the voltage difference between the base and the emitter of the first transistor Q1 can be less than 0.7 volts, the first transistor Q1 can turn off, which can cause the audio outputting module 30 to stop outputting tone frequency.

In use, the electronic device 100 can be capable of outputting different tone frequencies based on different driving voltage of the electronic device 100.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An electronic device, comprising:
a power supply for providing working voltage;
an audio outputting module; and
an adjustment circuit connected between the power supply and the audio outputting module for generating different driving voltages to the audio outputting module, the adjustment circuit comprising:
a control unit for outputting control signal;
a switch unit connected to the power supply, the control unit, and the adjustment unit; and
an adjustment unit connected to the control unit, the switch unit, and the adjustment unit;
wherein the switch unit receives the working voltage, the control unit comprises a first pin and a second pin; both of the first pin and the second pin are capable of outputting a first control signal; when the switch unit received first control signal from either the first pin or the second pin, the switch unit establishes a connection between the power supply and the adjustment unit, and the adjustment unit generates different driving voltages based on the first control signal outputted by the first pin and the second pin, the audio outputting module generates different tone frequencies based on different driving voltages.

2. The electronic device of claim 1, wherein when both of the first pin and the second pin output the first control signal, the switch unit establishes the connection and the adjustment unit generates a first driving voltage for controlling the audio outputting module to generate a first tone frequency.

3. The electronic device of claim 1, wherein both of the first pin and the second pin are capable of outputting a second control signal; when the first pin outputs the first control signal and the second pin outputs the second control signal, the switch unit establishes the connection and the adjustment unit generates a second driving voltage for controlling the audio outputting module to generate a second tone frequency.

4. The electronic device of claim 3, wherein when the first pin outputs the second control signal and the second pin outputs the first control signal, the switch unit establishes the connection and the adjustment unit generates a third driving voltage for controlling the audio outputting module to generate a third tone frequency.

5. The electronic device of claim 3, wherein the value of the first driving voltage, the second driving voltage, and the third driving voltage are progressively decreased in that order; the first driving voltage is equal to the working voltage.

6. The electronic device of claim 1, wherein when both of the of the first pin and the second pin output the second control signal, the switch unit cuts off the connection and the audio outputting module stops generating tone frequency.

7. The electronic device of claim 1, wherein the switch unit comprises a first transistor, a first diode, a second diode, and a first resistor; a base of the first transistor is connected to the first pin through the first diode; an emitter of the first transistor is connected to the adjustment unit; a collector of the first transistor is connected to the power supply, an anode of the first diode is connected to the first pin; a cathode of the first diode is connected to the base of the first transistor; an anode of the second diode is connected to the second pin; a cathode of the second diode is connected to the base of the first transistor; a terminal of the first resistor is connected to the base of the first transistor; an opposite terminal of the first resistor is grounded.

8. The electronic device of claim 1, wherein the adjustment unit comprises a second transistor, a third transistor, a third diode, a first limiting resistor, a second limiting resistor, and the third limiting resistor; a gate of the second transistor is connected to the first pin; a source of the second transistor is connected to the emitter of the first transistor; a drain of the second transistor is connected to the audio outputting module; a gate of the third transistor is connected to the second pin; a source of the third transistor is grounded; a drain of the third transistor is connected to the audio outputting module through the third diode; an anode of the third diode is connected to the drain of the third transistor; a cathode of the third diode is connected to the drain of the second transistor; the first limiting resistor is connected between the source and the drain of the second transistor; the second limiting resistor is connected between the source and the drain of the third transistor; the third limiting resistor is connected between the gate and the source of the third transistor.

9. An adjustment circuit connected between the power supply and the audio outputting module for generating different driving voltages to the audio outputting module, the adjustment circuit comprising:
a control unit for outputting control signal;
a switch unit connected to the power supply, the control unit, and the adjustment unit; and
an adjustment unit connected to the control unit, the switch unit, and the adjustment unit;
wherein the control unit comprises a first pin and a second pin; both of the first pin and the second pin are capable of outputting a first control signal; when the switch unit received first control signal from the first pin or the second pin, the switch unit establishes a connection between the power supply and the adjustment unit, and the adjustment unit generates different driving voltages based on the first control signal outputted by the first pin and the second pin, the audio outputting module generates different tone frequencies based on different driving voltage.

10. The adjustment circuit of claim 9, wherein when both of the first pin and the second pin output the first control signal, the switch unit establishes the connection and the adjustment unit generates a first driving voltage for controlling the audio outputting module to generate a first tone frequency.

11. The adjustment circuit of claim 10, wherein when the first pin outputs the first control signal and the second pin outputs the second control signal, the switch unit establishes the connection and the adjustment unit generates a second driving voltage for controlling the audio outputting module to generate a second tone frequency.

12. The adjustment circuit of claim 11, wherein when the first pin outputs the second control signal and the second pin outputs the first control signal, the switch unit establishes the connection and the adjustment unit generates a third driving voltage for controlling the audio outputting module to generate a third tone frequency.

13. The adjustment circuit of claim 13, wherein the value of the first driving voltage, the second driving voltage, and the third driving voltage are progressively decreased in that order; the first driving voltage is equal to the working voltage.

14. The adjustment circuit of claim 9, wherein when both of the of the first pin and the second pin output the second control signal, the switch unit cuts off the connection and the audio outputting module stops generating tone frequency.

15. The adjustment circuit of claim 9, wherein the switch unit comprises a first transistor, a first diode, a second diode, and a first resistor; a base of the first transistor is connected to the first pin through the first diode; an emitter of the first transistor is connected to the adjustment unit; a collector of the first transistor is connected to the power supply, an anode of the first diode is connected to the first pin; a cathode of the first diode is connected to the base of the first transistor; an anode of the second diode is connected to the second pin; a cathode of the second diode is connected to the base of the first transistor; a terminal of the first resistor is connected to the base of the first transistor; an opposite terminal of the first resistor is grounded.

16. The adjustment circuit of claim 9, wherein the adjustment unit comprises a second transistor, a third transistor, a third diode, a first limiting resistor, a second limiting resistor, and the third limiting resistor; a gate of the second transistor is connected to the first pin; a source of the second transistor is connected to the emitter of the first transistor; a drain of the second transistor is connected to the audio outputting module; a gate of the third transistor is connected to the second pin;
a source of the third transistor is grounded; a drain of the third transistor is connected to the audio outputting module through the third diode; an anode of the third diode is connected to the drain of the third transistor; a cathode of the third diode is connected to the drain of the second transistor; the first limiting resistor is connected between the source and the drain of the second transistor; the second limiting resistor is connected between the source and the drain of the third transistor; the third limiting resistor is connected between the gate and the source of the third transistor.
